(19) United States
(12) Patent Application Publication
(10) Pub. No.: US 2010/0143102 A1
(43) Pub. Date: Jun. 10, 2010

(54) COMPLIANT PLATE SEAL WITH SELF-CORRECTING BEHAVIOR

(75) Inventors: Hrishikesh Vishvas Deo, Saratoga Springs, NY (US); Norman Arnold Turnquist, Carlisle, NY (US); Barbaros Yildirim, Istanbul (TR)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/705,775

(22) Filed: Feb. 15, 2010

Related U.S. Application Data
(63) Continuation-in-part of application No. 12/032,929, filed on Feb. 18, 2008.

(51) Int. Cl. F01D 11/02; F16J 15/447; F01D 11/00; F16J 15/44

(52) U.S. Cl. 415/173.1; 277/418; 277/303

(57) ABSTRACT

A self-correcting seal assembly comprises a plurality of compliant plates coupled circumferentially to a stationary component, at least one slot in the compliant plates extending from the stationary component towards a rotor; and a resistance member coupled to a stationary component. The resistance member comprising at least one annular ring extending from the stationary component towards a rotor and through the slot. The seal assembly is configured to create passive feedback on hydrostatic forces in response to a tip-clearance between the rotor and tips of the compliant plates.

### CROSS-REFERENCE TO RELATED APPLICATION

This application is a continuation-in-part of co-owned, co-pending U.S. patent application Ser. No. 12/032,929 entitled “COMPLIANT PLATE SEAL WITH AN ANNULAR RING FOR TURBOMACHINERY AND METHODS OF ASSEMBLING THE SAME,” filed Feb. 18, 2008, which application is herein incorporated by reference in its entirety.

### BACKGROUND

This invention relates generally to a sealing structure between a rotating component and a stationary component and, more particularly, to a compliant plate seal arrangement with self-correcting behavior that allows high differential pressure capability, reduces leakage, and enables non-contact operation.

Dynamic sealing between a rotor (e.g., rotating shaft) and a stator (e.g., static shell or casing) is an important concern in turbomachinery. Several methods of sealing such as labyrinth seal, brush seal and compliant plate seal have been used. Conventionally, a non-contact labyrinth seal is commonly used. At certain sealing locations with large rotor transients, labyrinth seals are assembled with relatively large radial clearance to avoid contact of the labyrinth teeth with the rotor and further opening of the radial clearance. Known labyrinth seals are based on rigid members and have a high differential pressure capability, but their leakage is relatively large due to the large radial clearance.

Brush seals consist of tightly packed, cylindrical bristles that are arranged in a staggered arrangement to reduce leakage. The bristles have a low radial stiffness that allows them to move in the event of a rotor excursion while maintaining a tight effective clearance during steady state operation. Brush seals also have a low stiffness in the axial direction because of the generally cylindrical geometry of the bristles. When subject to a high differential pressure across the seal, the bristles deflect in the axial direction towards the low-pressure side. This opens up the radial clearance and leads to high leakage across the brush seal. Brush seals therefore are generally effective only up to a limited differential pressure across the seal. Moreover, the bristles of a brush seal rub against the rotor surface leading to abrasion wear and heating of the rotor and the bristles. As a result, the bristles have to be made out of expensive material with wear resistance at elevated temperatures. The abrasion wear leads to opening of the clearances and requires frequent replacement of the expensive brush seals. Rotor heating may also lead to rotor-dynamic instability.

Some known compliant plate seals have been used as an alternative to brush seals. Conventional compliant plate seals include compliant plates attached to a stator in a circumferential fashion around a rotor. Compliant plates have increased differential pressure capability due to larger axial stiffness to radial stiffness ratio of the compliant plates compared to bristles in brush seals. But the differential pressure capability of conventional compliant plates is limited due to the uncontrollable hydrostatic lift and blow-down phenomenon.

It would therefore be desirable to introduce passive feedback in the hydrostatic lift or blowdown forces acting on the compliant plates, such that the forces balance at a small tip-clearance and achieve robust non-contact operation, low leakage and high differential pressure capability.

### BRIEF DESCRIPTION

In accordance with one embodiment disclosed herein, a self-correcting seal assembly comprises a plurality of compliant plates coupled circumferentially to a stationary component, at least one slot in each of the compliant plates extending from the stationary component towards a rotor, and a resistance member coupled to a stationary component. The resistance member comprising at least one annular ring extending from the stationary component towards a rotor and through the slots. The seal assembly is configured to create passive feedback on hydrostatic forces in response to a tip-clearance between the rotor and tips of the compliant plates.

In accordance with another embodiment disclosed herein, a method of providing self-correcting comprises enabling a leakage flow from a high-pressure side of compliant plate seals to a low-pressure side of the compliant plate seals and providing a barrier to a component of the leakage flow to create passive feedback on hydrostatic forces in response to a tip-clearance between a rotor and tips of the compliant plates.

In accordance with another embodiment disclosed herein, a turbo machine comprises a stationary component, a rotor coupled adjacent to said stationary component, and a self-correcting seal assembly coupled between said stationary component and said rotor. The self-correcting seal assembly comprises a plurality of compliant plates coupled circumferentially to a stationary component, at least one slot in each of the compliant plates extending from the stationary component towards a rotor, and a resistance member coupled to a stationary component. The resistance member comprising at least one annular ring extending from the stationary component towards a rotor and through the slots. The seal assembly is configured to create passive feedback on hydrostatic forces in response to a tip-clearance between the rotor and tips of the compliant plates.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a cross-sectional view conventional compliant plate seal.

FIG. 2 illustrates a cross-sectional view conventional compliant plate seal where the front plate gap is less than the back plate gap.

FIG. 3 illustrates axial view of section A-A of FIG. 2 that shows the forces on a compliant plate.

FIG. 4 illustrates a cross-sectional view conventional compliant plate seal where the front plate gap is more than the back plate gap. Please reverse direction of B-B.

FIG. 5 illustrates axial view of section B-B of FIG. 4 that shows the forces on a compliant plate.

FIG. 6 is a perspective view of an embodiment of the compliant seal assembly in accordance with aspects disclosed herein.

FIG. 7 is a cross-sectional view of an embodiment of the compliant seal assembly taken along line 2-2 of FIG. 6 in accordance with aspects disclosed herein.

FIG. 8 illustrates two components of the leakage flow through the compliant plate seal in accordance with aspects disclosed herein.

FIG. 9 shows the forces acting on the compliant plate close to the annular ring front gap in accordance with aspects disclosed herein.

FIG. 10 shows the forces acting on the compliant plate close to the annular ring back gap in accordance with aspects disclosed herein.

FIG. 11 shows how the hydrostatic force can change with changing tip-clearance in accordance with aspects disclosed herein.

FIG. 12 shows the changes in self-correcting behavior for different operating conditions in accordance with aspects disclosed herein.

### DETAILED DESCRIPTION

Embodiments disclosed herein include a compliant plate seal assembly with self-correcting hydrostatic lift and hydrostatic blow-down behavior. The compliant plate seal assembly described herein may be used with any suitable rotary machine such as, but not limited to, gas turbines, steam turbines, compressors, aircraft engines and other turbomachinery. The seal assembly includes a plurality of compliant plates coupled circumferentially to the stationary component, wherein each of the plurality of compliant plates comprises a tip, a root, opposing first and second side surfaces, a leading surface at a high pressure side, a trailing surface at a low pressure side, and at least one slot extending from the stationary component partway to the rotor. The seal assembly includes at least one annular ring coupled to a stationary component that extends through the slots in the compliant plate stack from the stationary component towards a rotor.

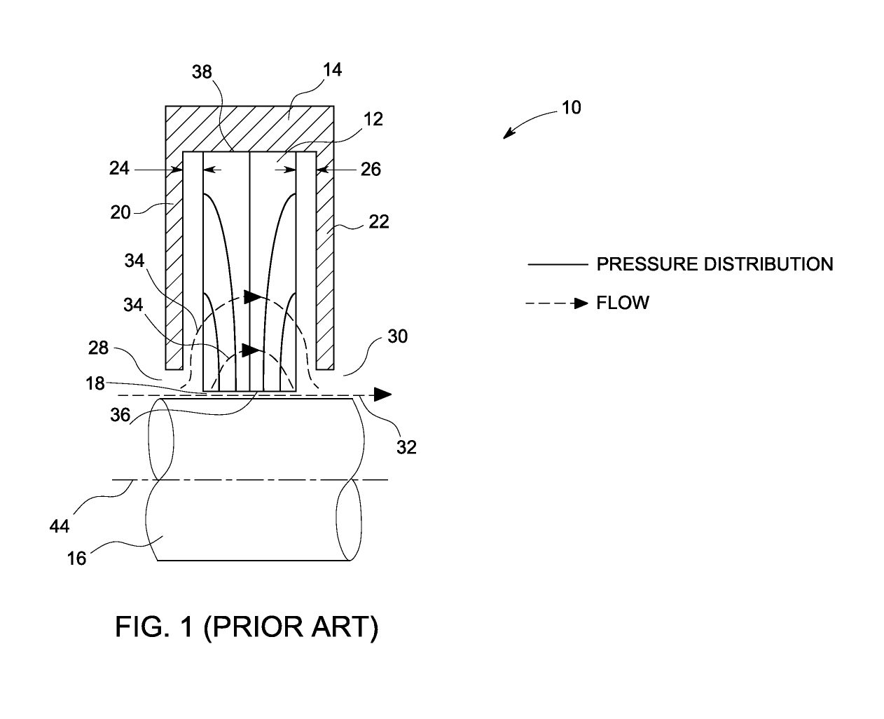

FIG. 1 illustrates a conventional compliant plate seal 10. Conventional compliant plate seals 10 include compliant plates 12 attached to a stator 14 in a circumferential fashion around a rotor 16. There is a clearance between the tips of the compliant plates and the rotor that is referred as tip clearance 18. The tips of adjacent compliant plates 12 also have a small but finite gap so that they are free to move in the radial direction. The compliant plate seal 10 also includes a front plate 20 and a back plate 22 separated from the complaint plate stack by a small distance that can be referred as a front plate gap 24 and a back plate gap 26, respectively. The front plate 20 and back plate 22 have a relatively large radial clearance from the rotor 16 that is called as fence height. Conventional compliant plate seals consist of compliant plates attached to the stator at the seal outer diameter, in a circumferential fashion around the rotor.

The compliant plates 12 are substantially parallel to the axis 44 of the rotor 16. The compliant plates 12 can be oriented at an angle with respect to the radial direction of the rotor 16 such that the compliant plate 12 from the tip to the root leans towards the opposite direction of the of the shaft rotation. The root refers to the end of the compliant plate that is attached to the stator and the tip refers to the free end of the compliant plate 12 that is in close proximity to the rotor 16. The angle that the compliant plate 12 makes with the circumferential direction of the rotor 16 is known as the cant angle. The tips of adjacent compliant plates 12 have a small but finite gap between each other, so that they are free to move in the radial direction at the seal inner diameter, while keeping the leakage area small. The gaps between adjacent compliant plates 12 increase along the length of the plates, from the tip of the compliant plate to the root of the compliant plate.

The leakage flow from the high-pressure side 28 to the low-pressure side 30 consists of two components. A first component 32 is the flow through the tip clearance 18 and a second component 34 is the flow through the gaps between the adjacent compliant plates 12. The flow-field and the pressure profile resulting from this leakage flow depend on the geometry and the operating conditions such as pressure, fluid, RPM, and swirl. An exemplary flow field and pressure distribution is shown with arrows in FIG. 1. Close to the front plate 20, the second component of leakage flow 34 component is radially outward, and from high-pressure side 28 to low-pressure side 30. Close to the back plate 22 the second component of leakage flow 34 is radially inward and from high-pressure side 28 to low-pressure side 30.

The gaps between adjacent compliant plates 12 increase along the length of the plates, from the tip 36 of the compliant plate to the root 38 of the compliant plate. These gaps have a large flow area and a small flow-resistance to the leakage flow 34. The primary resistance to the second component of the leakage flow 34 is provided by the front plate gap 24 and back plate gap 26. In known compliant plates such as the seal 10 in FIG. 1, the differential pressure across the seal 10 (from high-pressure side to low-pressure side) causes either a lifting force or blow-down force on the compliant plates, depending on the ratio of the front plate gap 24 to the back plate gap 26. This force is referred to as the hydrostatic force.

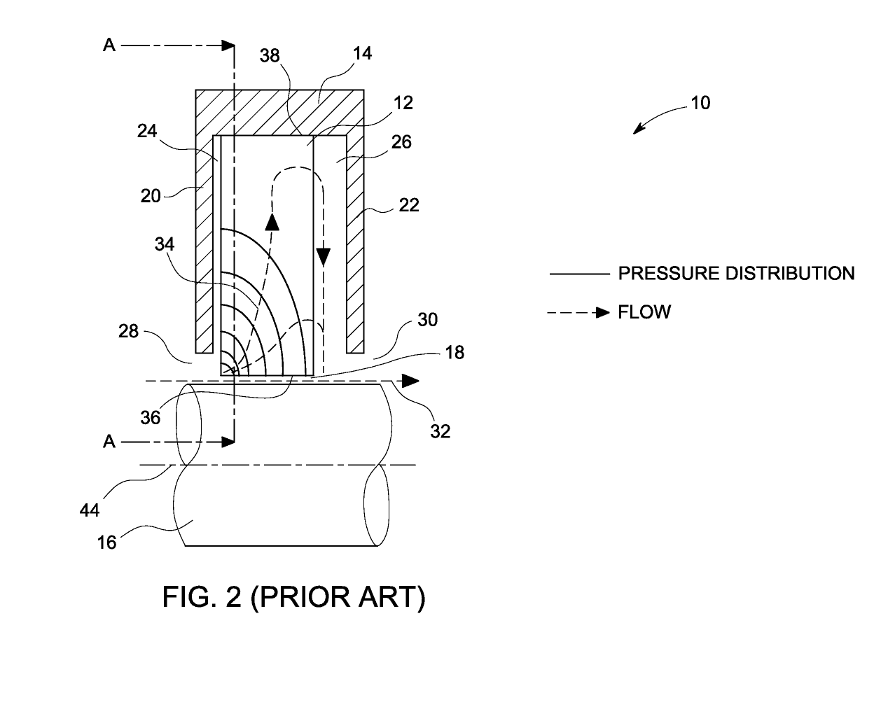

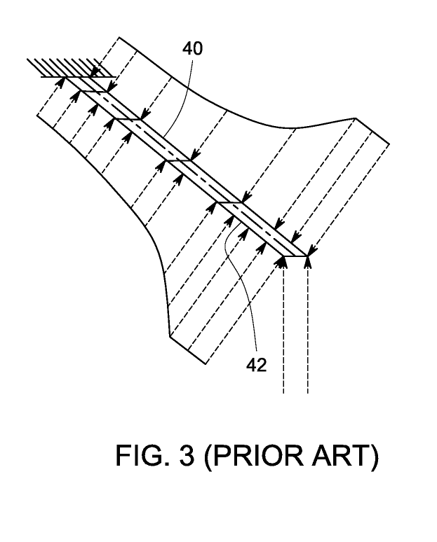

Referring to FIGS. 2 and 3, the pressure profile due to the leakage flow depends on the ratio of the front plate gap 24 to the back plate gap 26. When the front plate gap 24 is smaller than the back plate gap 26 as shown in FIG. 2, the radial pressure gradient is negative at section A-A, i.e., the pressure reduces from the seal inner diameter to the seal outer diameter. As a result of the negative radial pressure gradient and the cant angle (the angle that the compliant plates make with the circumferential direction of the rotor), the pressure on the top face 40 of the compliant plate 12 is slightly lower than the pressure on the bottom face 42 of the compliant plate 12. This results in a resultant hydrostatic lift force on the compliant plate 12.

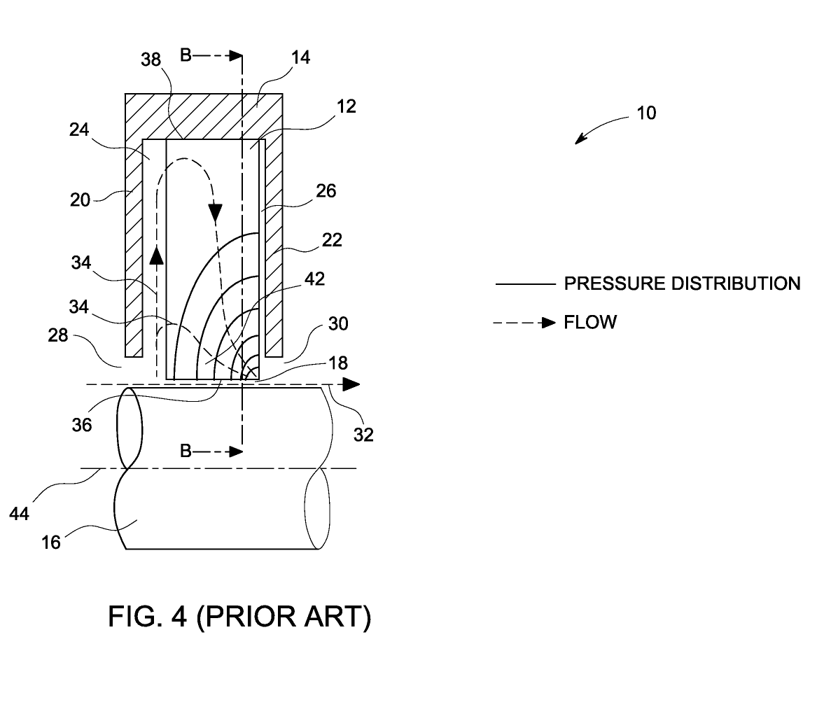

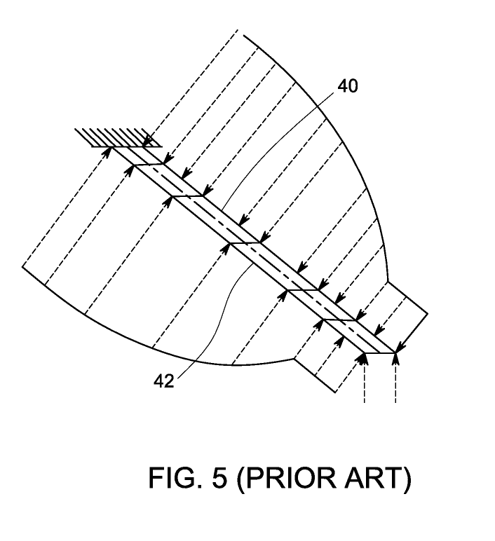

Referring to FIGS. 4 and 5, in another scenario, when the front plate gap 24 is larger than the back plate gap 26 as shown in FIG. 3, the radial pressure gradient is positive at section B-B, i.e., the pressure increases from the seal inner diameter to the seal outer diameter. As a result of the positive radial pressure gradient and the cant angle, the pressure on the top face 40 of the compliant plate 12 is slightly higher than the pressure on the bottom face 42 of the compliant plate 12. This results in a resultant hydrostatic blow-down force on the compliant plate 12.

There can also be a small lift force on the compliant plates due to the rotation of the shaft, referred to as the hydrodynamic lift force. The hydrostatic lift and blow-down forces are much larger than the hydrodynamic lift force. Therefore, it may not be possible to reliably provide a small tip-clearance or non-contact operation using hydrodynamic force because the larger hydrostatic lift/blow-down force is not controllable.

The hydrostatic lift and blow-down forces are sensitive to variations in the front plate gap 24 and the back plate gap 26. A compliant plate seal with smaller front plate gap 24 has an effective hydrostatic lift force, and such a seal may lift-off completely at low differential pressures and open up the radial tip-clearance leading to high leakage. A compliant plate seal with smaller back-plate gap 26 has an effective hydrostatic blow-down force, and may blow down completely for a certain (low) differential pressure, and rub against the rotor leading to wear, heating and rotor-dynamic issues.

The front plate gap 24 and the back plate gap 26 need to be very small (around 5 mils) for low leakage, and therefore any small manufacturing variation (for example, +/−1 mil) in the front plate gap 24 or back plate gap 26 can change the front plate gap to back plate gap ratio significantly. This will in turn change the lift/blow-down behavior of the seal significantly. Moreover, due to the differential pressure across the compliant plate seal 10 and the viscous forces acting on the compliant plate seal 10 due to the leakage flow, the compliant plates 12 may deflect slightly in the axial direction 44. The deflection in the compliant plates alters the front plate gap 24 and the back plate gap 26, and also the resulting hydrostatic lift/blow-down behavior. Therefore, the hydrostatic force on the conventional compliant plates 12 may not be controllable. The conventional compliant plate seal 10 may not maintain non-contact operation and low leakage under high differential pressure.

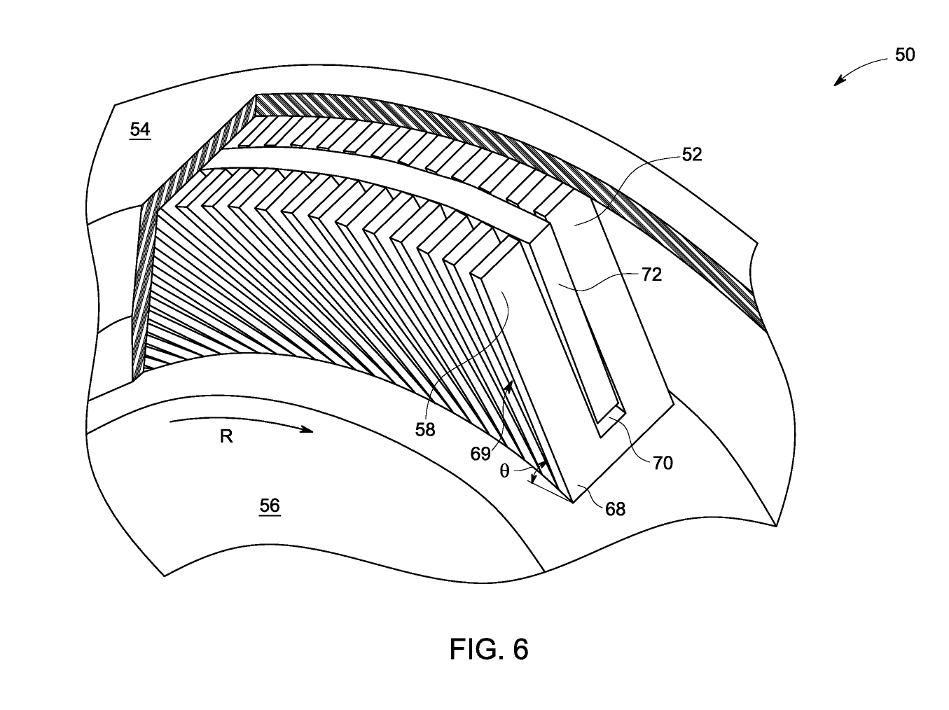

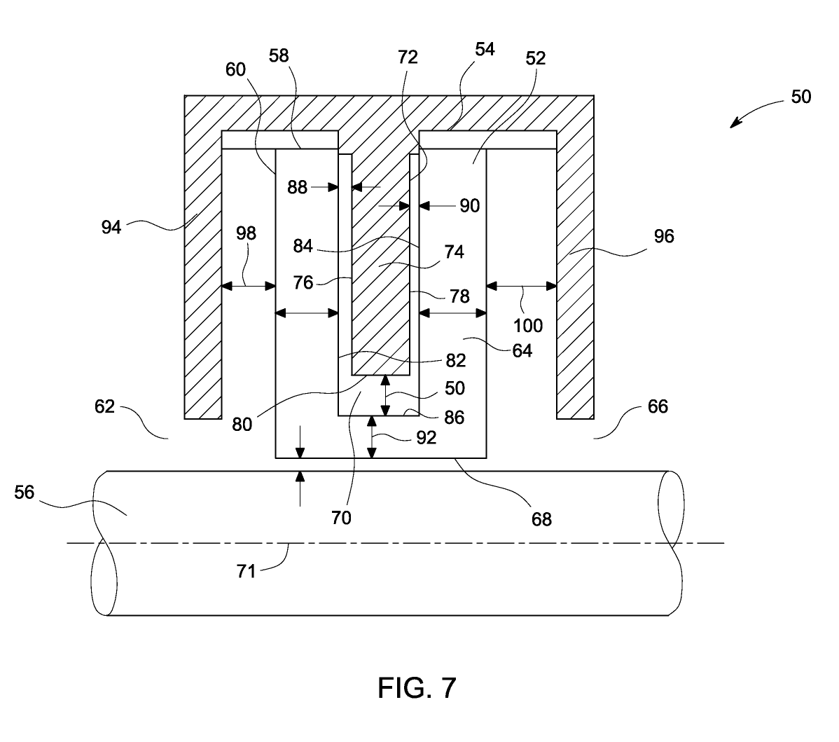

FIGS. 6 and 7 illustrate an embodiment of the compliant seal assembly 50 in accordance with one embodiment of the present invention. The seal assembly 50 includes compliant plates 52 attached to a stator 54 or a stationary component at the seal outer diameter in a circumferential fashion around a rotor 56. The compliant plates 52 are secured at their roots 58, in a facing relation (i.e., face-to-face), to the stator 54. The root 58 refers to the end of the compliant plate that is attached to the stator. As used herein, the term “facing relation” refers an orientation in which a first side surface of one compliant plate is adjacent to a second side surface of an immediate adjacent compliant plate. Each side surface extends from a leading surface 60 at a high-pressure side 62 to a trailing surface 64 at a low-pressure side 66 of each compliant plate 52, and from the root 58 to a tip 68 of each compliant plate 12. The tip 68 refers to the free end of the compliant plate 52 that is in close proximity to the rotor 56.

The compliant plates are substantially parallel to the axis 71 of the rotor 56, and the resistance member 72 is concentric with the rotor 56. The compliant plates 52 can be oriented at an angle with respect to the radial direction of the rotor 56 such that the complaint plate 72 from the tip 68 to the root 58 leans towards the opposite direction of the of the shaft rotation (R). The angle that the compliant plate 52 makes with the circumferential direction of the rotor 56 is known as the cant angle ‘θ’.

The compliant plates 52 have a slot 70 extending a length from the root 58 towards the tip 68. The slot 70 does not extend up to the tip 68. The seal assembly 50 further includes a resistance member 72 that extends into the slot 70 of the compliant plates 52. The resistance member 72 acts as a barrier to axial leakage flow between the compliant plates 52. More specifically, in the exemplary embodiment, the resistance member 72 extends circumferentially about stator 54, and extends radially inward from stator 54 towards rotor 56. In the exemplary embodiment, the resistance member 72 includes at least one annular ring 74 that is coupled to the stator 54 and extends radially into the slot 70.

In alternative embodiments, the seal assembly can include a plurality of the slots and a plurality of the annular rings with varying dimensions such that each annular ring extends into a respective slot. Various embodiments of the seal assembly such as installation of the seal assembly are described in co-owned, co-pending U.S. patent application Ser. No. 12/032,929 entitled “COMPLIANT PLATES WITH AN ANNULAR RING FOR TURBOMACHINERY AND METHODS OF ASSEMBLING THE SAME.” The self-correcting behavior of the seal assembly is described for the seal assembly with one annular ring. However, the self-correcting behavior is applicable to the seal assembly with multiple annular rings and slots.

The annular ring includes a leading surface 76 facing the high-pressure side 62, a trailing surface 78 facing the low pressure side 66, and a tip 80. The slot 70 includes a first surface 82 that faces the leading surface 76 of the annular ring 74, a second surface 84 that faces the trailing surface 78 of the annular ring 74, and a third surface 86 that faces the tip 80 of the annular ring 74. An annular ring front gap 88 is defined between the first surface 82 of the slot 70 and the leading surface 76 of the annular ring 74. An annular ring back gap 90 is defined between the second surface 84 of the slot 70 and the trailing surface 78 of the annular ring 74. A bridge gap is defined between the third surface 86 of the slot 70 with the tip 80 of the annular ring 74. The radial distance between the tip of the annular ring 74 and the slot 70 is referred to as the bridge gap 92.

The seal assembly 50 may further include a front ring 94 and a back ring 96, both coupled to the stator 54. The front ring 94 extends circumferentially across the leading surfaces 60 of the compliant plates 52 and the back ring 96 extends circumferentially across the trailing surfaces 64 of the compliant plates 52. A gap defined between front ring 94 and leading surfaces 60 is referred as the front ring gap 98, and a gap defined between back ring 96 and trailing surfaces 64 is referred as the back ring gap 100. The front ring gap 98 and the back ring gap 100 may be made small or large. The behavior of the seal 50 does not depend critically on the front ring gap 98 and the back ring gap 100.

The compliant plates 52 are substantially parallel to the axis 74 of the rotor 56 or may be arranged at an angle with respect to the axis 71 of the rotor 56. The annular ring 74 is concentric with the rotor 56. The angle that the compliant plate 52 makes with the circumferential direction of the rotor 56 is known as the cant angle. The tips 68 of adjacent compliant plates 52 are separated by a small gap so that they are free to move in the radial direction. The compliant plates 52 have a significantly higher ratio of axial stiffness to radial stiffness compared to the bristles in a brush seal.

In the exemplary embodiment, each compliant plate 52 is substantially planar, or flat, along each side surface. Alternatively, the compliant plates 52 may be other than substantially planar. For example, the compliant plates may be curved 102, bent at one or multiple locations 104, or include varying thickness 106.

The annular ring 74 may be a continuous 360-degree ring concentric with the rotor 56. In other embodiments, the annular ring 74 can be split into several segments such as 6 segments of about 60-degrees each or 4 segments of about 90-degrees each.

A varying gap 69 can be formed between the adjacent compliant plates 52. The gaps between adjacent compliant plates 52 can increase along the length of the compliant plates from the tip 68 of the compliant plates 52 to the root 58 of the compliant plates 52. The compliant plates 52 can be oriented at an angle with respect to the radial direction of the rotor 56 such that the complaint plate 52 from the tip 68 to the root 58 lean in a direction opposite to the direction of the rotation of the rotor 56.

When compliant plates have substantially constant thickness, the gap 110 tapers from outer portion of the seal to inner portion of the seal. As such, the compliant plates 52 may be considered to be as “loosely packed” at the root 58, and “closely packed” the tips 68. The term “closely packed,” as used herein, refers to an orientation in which adjacent plate tips are not in contact with each other but are closely spaced, for example, but not limited to, being spaced by approximately 0.2 mils. When, for example, seal assembly 50 has a small diameter (not shown), such as, a diameter of less than approximately 8 inches, gaps diverge significantly from inner portion to outer portion, and when seal assembly 50 has a larger diameter (not shown), such as, a diameter larger than approximately 15 inches, gaps may be substantially constant from outer portion to inner portion. In an alternative embodiment, the thickness of compliant plates may vary from root to tip, and gaps will vary accordingly.

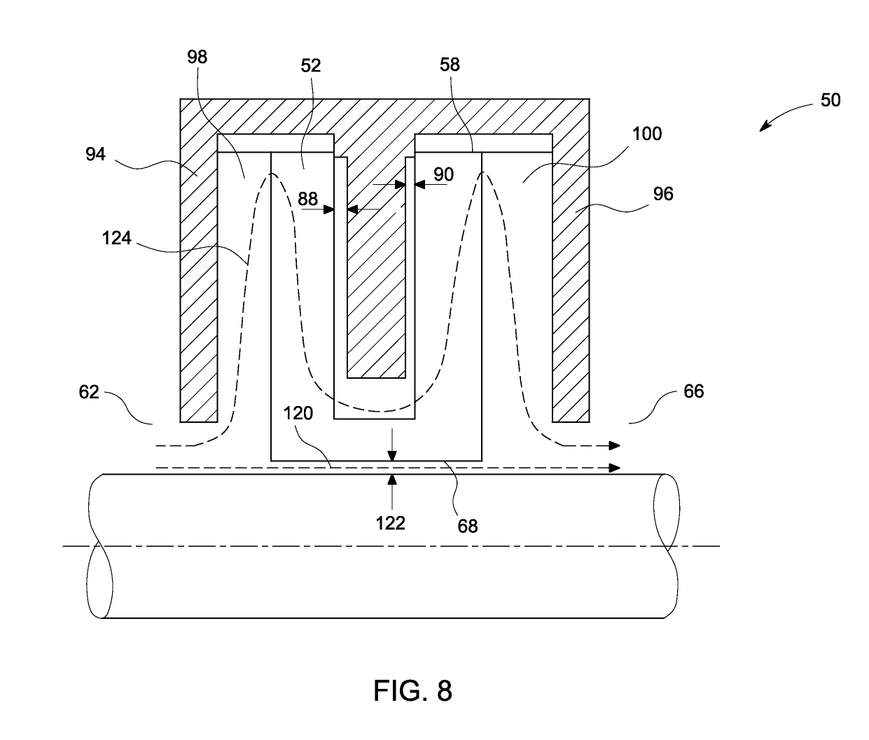

Referring to FIG. 8, a leakage flow from the high-pressure side 62 to the low-pressure side 64 includes two components. A first component 120 of the leakage flow is through the tip clearance 122. The tip clearance 122 is the gap between the tip 68 and the rotor 56. A second component 124 is through the gaps between the adjacent compliant plates 52. Close to the front ring 94 and the back ring 96, the flow resistance to the second component 124 of the leakage flow is small because of the relatively large front ring gap 98 and large back ring gap 100.

As discussed previously, the gaps between adjacent compliant plates 52 increase from the tip 68 to the root 58. These gaps provide a large flow area and a small flow-resistance to the leakage flow 124. The primary resistance to the second component of the leakage flow 124 is provided by the front gap 88 and the back gap 90. Therefore, the annular ring front gap 88 and the annular ring back gap 90 have to be relatively small (for example, around a few mils) to limit the leakage flow.

Close to the annular ring front gap 88, the leakage flow 124 is radially inward and from high-pressure side 62 to low-pressure side 66. Whereas close to the annular ring back gap 90, the flow 124 is radially outward and from the high-pressure side 62 to the low-pressure side 66. The flow-field and the pressure profile resulting from this leakage depends on the geometry and the operating conditions such as, for example, differential pressure, pressure ratio, fluid properties, fluid temperature, engine rotation speed and swirl. Swirl is defined as ratio of the fluid tangential velocity to the tangential velocity of the rotor surface. Differential pressure refers to the difference between the high pressure and low pressure, and pressure ratio refers to the ratio of high pressure to low pressure.

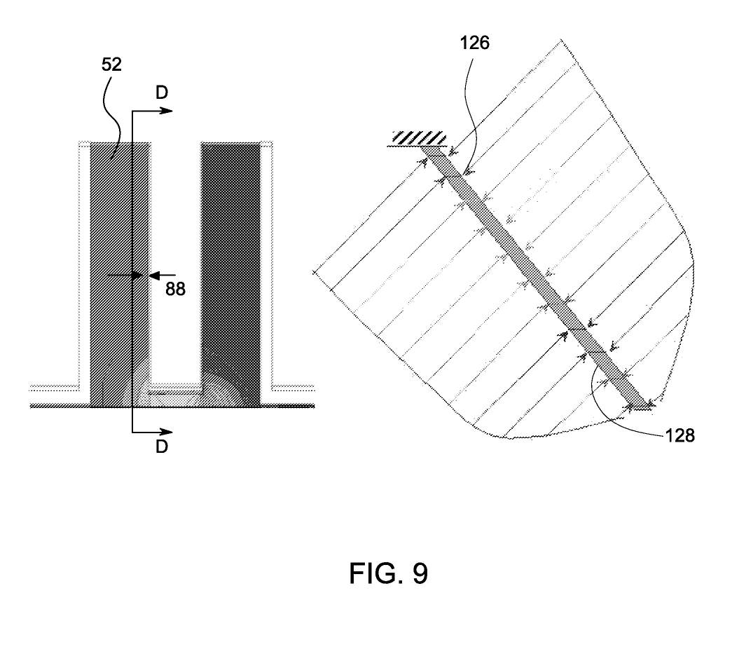

FIG. 9 illustrates pressure gradients close to the annular ring front gap 88. The radial pressure gradient close to the annular ring front gap 88 (Section D-D) is positive, i.e., the pressure increases from the seal inner diameter to the seal outer diameter. Arrows in the Section D-D indicate the pressure and length of the arrows is proportional to the pressure. As a result of the positive radial pressure gradient and the cant angle, the pressure on the top face 126 of the compliant plate 52 is slightly higher than the pressure on the bottom face 128 of the compliant plate 52 at Section D-D. This leads to a resultant hydrostatic blow-down force on this section (i.e. section D-D) of the compliant plate 52. The smaller the annular ring front gap 88, the larger the pressure gradient magnitude and greater the hydrostatic blow-down force.

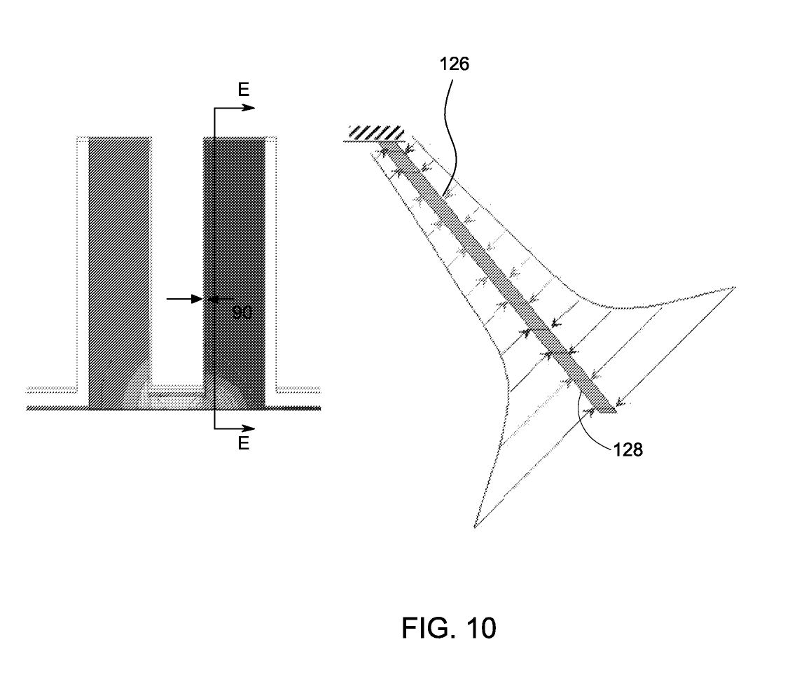

FIG. 10 illustrates pressure gradients close to the annular ring back gap 90. The radial pressure gradient close to the annular ring back gap 90 (Section E-E) is negative, i.e., the pressure decreases from the seal inner diameter to the seal outer diameter. Arrows in the Section E-E indicate the pressure and length of the arrows is proportional to the pressure. As a result of the negative radial pressure gradient and the cant angle, the pressure on the top face 126 of the compliant plate 52 is slightly lower than the pressure on the bottom face 128 of the compliant plate 52 at Section E-E. This leads to a resultant hydrostatic lift force on this section (Section E-E) of the compliant plate 52. The smaller the annular ring back gap 90, the larger the pressure gradient magnitude and greater the hydrostatic lift force.

The sum of the hydrostatic forces over the entire face (effective area) of the compliant plate determines whether the total hydrostatic force acting on the compliant plate is a lift force or a blow-down force. Therefore, the seal assembly can be designed with suitable annular ring front gap and suitable annular ring back gap such that there is an effective hydrostatic lift force acting on the compliant plate for a small tip clearance (for example, about 0.5 mils).

Referring to FIGS. 8-10, when the tip clearance 122 increases to a larger value (for example, about 5 mils), the flow-area for the first component 122 of the leakage flow (through the tip clearance) increases and the associated flow-resistance reduces. As a result, the flow velocity of the first component 122 of the leakage flow increases significantly and the static pressure close to the tip 68 reduces as compared to the case with small tip clearance. The flow resistance to the second component 124 of the leakage flow remains substantially the same and the velocity of the second component 124 of the leakage flow remains substantially the same. As a result, the pressure at the entrance of the compliant plate 52 (near the front ring 94 and away from the tip 68) remains substantially the same as in the case of the small tip gap.

Comparing the two cases of smaller tip clearance and larger tip clearance, the pressure close to the tip 68 is lower for the larger tip clearance, whereas the pressures close to the root 58 are substantially the same in both cases. As a result, for larger tip clearance, a more positive radial pressure gradient or less negative radial pressure gradient is present. As discussed earlier, a more positive radial pressure gradient or less negative radial pressure gradient leads to a greater blow-down force or lower lift-off force on the compliant plates 52, causing the compliant plates 52 to blow down and the tip-clearance 122 to reduce.

This hydrostatic blow-down force acting on the compliant plates 52, when the tip clearance 122 increases, tends to reduce the tip-clearance 122. This leads to self-correcting hydrostatic lift/blow-down force with passive feedback from tip-clearance. This passive feedback causes the compliant plates to maintain a small tip-clearance between the compliant plates and the rotor, and the effective hydrostatic lift/blow-down forces acting on the compliant plates is balanced at that tip clearance. Therefore, the tip clearance is maintained.

The hydrostatic lift/blow-down forces discussed earlier are due a differential pressure applied between the high-pressure side and the low-pressure side and the resulting leakage flow. This is different as compared to the hydrodynamic lift force created by the rotation of the rotor.

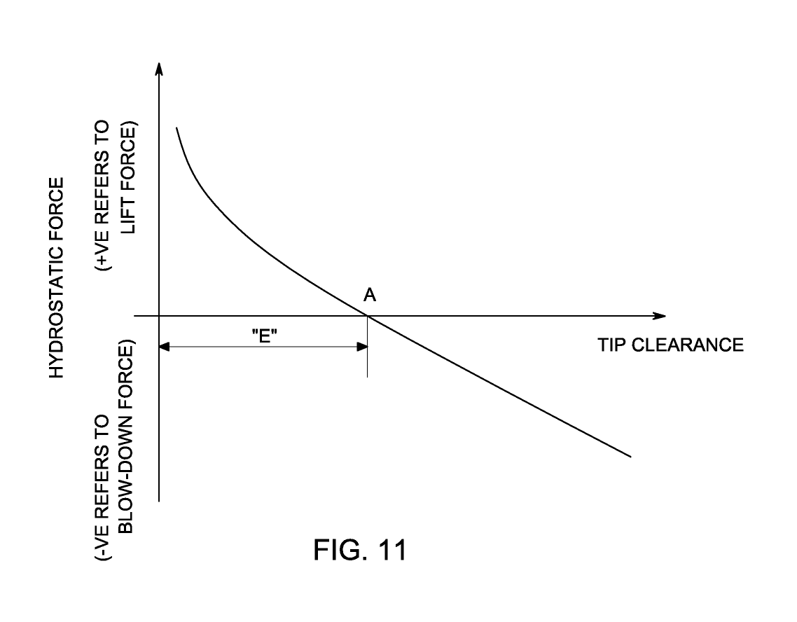

The change in total hydrostatic force acting on the compliant plate with changing tip-clearance for an exemplary embodiment is illustrated in FIG. 11. The positive portion on the y-axis refers to hydrostatic lift force and negative portion on the y-axis refers to hydrostatic blow-down force. The tip clearance is represented on x-axis. The effective hydrostatic force is zero at a point ‘A’ on the x-axis. This means that the compliant plates are balanced at an effective clearance equal to ‘E’.

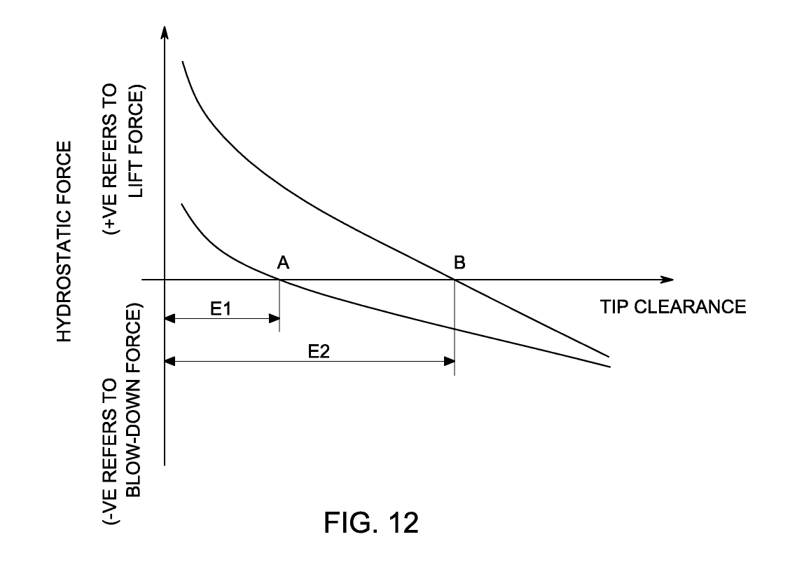

The tip clearance “E” at which there is zero hydrostatic force acting on the compliant plate depends on factors, including the geometry of the seal (such as annular ring front gap, annular ring back gap, compliant plate length, cant angle, bridge height, bridge gap, assembly clearance), and operational factors such as inlet swirl conditions, differential pressure, pressure ratio, RPM. A performance map can be created to determine the tip clearance ‘E’ for various combinations of factors. An exemplary performance map is shown in FIG. 12. Computational Fluid Dynamics (CFD) Simulations and Laboratory Prototype Tests have been performed to create the performance map. Referring to the performance map, the compliant plates are balanced at tip-clearance “E1” for a condition ‘1’, and are balanced at a different tip-clearance “E2” for a condition ‘2’.

Computational Fluid Dynamics (CFD) Simulations and Laboratory Prototype Tests indicated that this hydrostatic feedback is a robust phenomenon. A robust self-correcting behavior that is insensitive to differential pressure, pressure ratio, inlet swirl, annular ring front gap, annular back gap, errors (inaccuracies, variations or non-uniformities) in compliant plate seal manufacturing (such as cant angle, or length of the compliant plates, or bridge height or bridge gap), forward or reverse rotation of the rotor (and the associated hydrodynamic lift forces) is obtained. The self-correcting hydrostatic lift/blow-down behavior enables the seal assembly to achieve robust non-contact operation, even in the presence of large rotor transient.

Non-contact operation eliminates rotor heating and abrasion-wear in the compliant plates or the rotor. Since the compliant plates 52 maintain a small tip-clearance between the seal and the rotor due to the self-correcting behavior, the leakage can be limited to a small value. Low leakage in turbomachinery directly translates to improvement in efficiency and reduction in Specific Fuel Consumption.

The compliant plates 52 can maintain a small tip-clearance even at high differential pressures, thereby achieving the desired high differential pressure capability. Due to the passive feedback, the high differential pressure capability and the small tip-clearance can be achieved within a limited axial span. The advantages of high differential pressure capability and smaller axial span are well known. At several sealing locations (for instance, inter-stage seals in Steam Turbines or Gas Turbines), the axial length of the machine is dictated by the sealing requirements. At such locations, a seal with high differential pressure capability, low leakage and smaller axial span leads to reduction in the turbomachinery length. This leads to cost reduction in terms of rotor material and casing material costs. Axial span reduction also leads to reduction in bearing span (axial distance between two bearings) and associated reduction in rotor vibrations along the length of the rotor.

In turbomachinery, the rotor and stator may heat and cool at different rates and in an asymmetric fashion. This may cause relative distortions between the rotor and the stator. Due to the self-correcting behavior, the compliant plates 52 react to these distortions and maintain a small tip-clearance (low leakage) and non-contact operation, even in the presence of these rotor transients.

The compliant plates 52 have a very small thickness (around 5 mils) and have a very high natural frequency (about hundreds of Hertz). The self-correcting hydrostatic lift/blow-down forces add significant fluid stiffness, and negligible fluid inertia, thereby increasing the system natural frequency further (for example, more than 1000 Hz). The changes in the pressure profile and the hydrostatic lift/blow-down forces due to the tip-clearance changes are very rapid. Due to this, the compliant plates 52 can respond very rapidly to rotor transients caused by rotor vibration. Therefore, the seal 50 can maintain non-contact operation even in the presence of large high-frequency rotor transients.

The self-correcting hydrostatic behavior can reliably maintain non-contact operation for forward and reverse rotation of rotor, and also when the rotor is not in rotation. The seal assembly 50 can reliably maintain non-contact operation in the presence of low or high swirl. The seal assembly 50 can be assembled with large assembly clearance or assembly interference. In the case of assembly clearance, the compliant plates 52 blow down (as soon as there is flow or differential pressure) and maintain a small tip-clearance and non-contact operation. In case of assembly interference, the compliant plates 52 lift (as soon as there is flow or differential pressure) and maintain a small tip-clearance and non-contact operation.

CFD Simulations and Laboratory Prototype Tests indicated that the self-correcting phenomenon is insensitive to errors, variations, or non-uniformities in annular ring front-gap and annular ring back-gap dimensions. Self-correcting behavior and non-contact operation has been achieved for all three possible cases: (a) when annular ring front gap is greater than annular ring back gap, (b) when annular ring front gap is equal to annular ring back gap, and (c) annular ring front gap is less than annular ring back gap.

A direct consequence of the insensitivity to errors in annular ring front gap and annular ring back gap, and insensitivity to reverse rotation is that the self-correcting behavior will act even in the case of reverse pressurization or reverse leakage flow, i.e., when pressure on the high-pressure side is for some reason lower than the pressure on the low-pressure side.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A self correcting seal assembly, comprising:
a plurality of compliant plates coupled circumferentially to a stationary component;
at least one slot in each of the compliant plates extending from the stationary component towards a rotor; and
a resistance member coupled to a stationary component, the resistance member comprising at least one annular ring extending from the stationary component towards a rotor and through the slots;
wherein said seal assembly is configured to create passive feedback on hydrostatic forces in response to a tip-clearance between the rotor and tips of the compliant plates.

2. The seal assembly of claim 1, wherein self-correction is enabled with respect to a tip clearance between a tip of the compliant plates and the rotor.

3. The seal assembly of claim 2, wherein the leakage flow comprises at least a first component and a second component, the first component of the leakage flow is a flow through the tip clearance and the second component is a flow through the gaps between the adjacent compliant plates.

4. The seal assembly of claim 2, wherein a pressure difference between a high pressure side and a low pressure side of the seal assembly and a leakage flow through at least the tip clearance and gaps between the compliant plates create the hydrostatic forces.

5. The seal assembly of claim 4, wherein the hydrostatic forces comprise hydrostatic blow-down forces and hydrostatic lift forces, the hydrostatic blow-down forces blow down the compliant plates and reduce the tip clearance and hydrostatic lift forces lift the compliant plates and increase the tip clearance.

6. The seal assembly of claim 4, wherein when the compliant plates lift, the hydrostatic forces blow down the compliant plates to reduce the tip clearance, and when the compliant plates blow down, the hydrostatic forces lift the compliant plates to increase the tip-clearance, and the hydrostatic forces balance at a small tip-clearance, thereby achieving self-correction.

7. The seal assembly of claim 1, wherein the compliant plates are substantially parallel to an axis of the rotor and the annular ring is concentric with the rotor.

8. The seal assembly of claim 1, wherein the compliant plates are oriented at an angle with respect to a radial direction of the rotor.

9. The seal assembly of claim 1, wherein the compliant plates are at an angle with respect to an axis of the rotor.

10. The seal assembly of claim 1, wherein the annular ring is continuous around the rotor to form a 360-degree ring.

11. The seal assembly of claim 1, wherein the annular ring comprises a plurality of segments that are assembled around the rotor to form a 360-degree ring.

12. The seal assembly of claim 1, further comprises a front ring coupled to the stationary component on a high-pressure side of the compliant plates and a back ring coupled to the stationary component on a low-pressure side of the compliant plates.

13. The seal assembly of claim 1, wherein the compliant plates are curved bent at one or more locations, or have varying thickness along their length.

14. A method of providing self-correcting behavior for compliant plate seals, comprising:
enabling a leakage flow from a high-pressure side of compliant plate seals to a low-pressure side of the compliant plate seals and providing a barrier to a component of the leakage flow to create passive feedback on hydrostatic forces in response to a tip-clearance between a rotor and tips of the compliant plates.

15. The method of claim 15, enabling a leakage flow comprises:
enabling a first component of the leakage flow through a tip clearance between tip of the compliant plate seals and a rotor; and
enabling a second component of the leakage flow through gaps between the adjacent compliant plates.

16. The method of claim 15, wherein providing a barrier comprises providing a barrier to the second component of the leakage flow.

17. A turbo machine, comprising:
a stationary component;
a rotor coupled adjacent to said stationary component; and
a self-correcting seal assembly coupled between said stationary component and said rotor, said seal assembly comprising:
a plurality of compliant plates coupled circumferentially to the stationary component;
a slot in each of the compliant plates extending from the stationary component towards a rotor; and
a resistance member coupled to a stationary component, the resistance member comprising at least one annular ring extending from the stationary component towards a rotor and through the slots;
wherein said seal assembly is configured to create passive feedback on hydrostatic forces in response to a tip-clearance between the rotor and tips of the compliant plates.

18. The seal assembly of claim 17, wherein self-correction is enabled with respect to a tip clearance between a tip of the compliant plates and the rotor.

19. The seal assembly of claim 18, wherein the leakage flow comprises a first component and a second component, the first component of the leakage flow is a flow through the tip clearance and the second component is a flow through gaps between the adjacent compliant plates.

20. The seal assembly of claim 18, wherein a pressure difference between a high pressure side and a low pressure side of the seal assembly and a leakage flow through at least the tip clearance and gaps between the compliant plates create the hydrostatic forces.

21. The seal assembly of claim 20, wherein the hydrostatic forces comprise hydrostatic blow-down forces and hydrostatic lift forces, the hydrostatic blow-down forces blow down the compliant plates and reduce the tip clearance and hydrostatic lift forces lift the compliant plates and increase the tip clearance.

22. The seal assembly of claim 20, wherein when the compliant plates lift, the hydrostatic forces blow down the compliant plates to reduce the tip clearance, and when the compliant plates blow down, the hydrostatic forces lift the compliant plates to increase the tip-clearance, and the hydrostatic forces balance at a small tip-clearance, thereby achieving self-correction.
